(19) United States
(12) Patent Application Publication
(10) Pub. No.: US 2021/0327033 A1
(43) Pub. Date: Oct. 21, 2021

(54) VIDEO PROCESSING METHOD AND APPARATUS, AND COMPUTER STORAGE MEDIUM

(71) Applicant: SHENZHEN SENSETIME TECHNOLOGY CO., LTD., Shenzhen (CN)

(72) Inventors: Xiangyu XU, Shenzhen (CN); Muchen LI, Shenzhen (CN); Wenxiu SUN, Shenzhen (CN)

(73) Assignee: SHENZHEN SENSETIME TECHNOLOGY CO., LTD., Shenzhen (CN)

(21) Appl. No.: 17/362,883

(22) Filed: Jun. 29, 2021

Related U.S. Application Data
(63) Continuation of application No. PCT/CN2019/114458, filed on Oct. 30, 2019.

(30) Foreign Application Priority Data
Mar. 19, 2019 (CN) 201910210075.5

(51) Int. Cl. G06T 5/00

(52) U.S. Cl. CPC G06T 5/002; G06T 2207/20084; G06T 2207/20081; G06T 2207/10016

(57) ABSTRACT

A video processing method includes: a convolution parameter corresponding to a frame to be processed in a video sequence is acquired, the convolution parameter including a sampling point of a deformable convolution kernel and a weight of the sampling point; and denoising processing is performed on the frame to be processed based on the sampling point of the deformable convolution kernel and the weight of the sampling point to obtain a denoised video frame.

### CROSS-REFERENCE TO RELATED APPLICATION

The present application is a continuation of International Patent Application No. PCT/CN2019/114458 filed on Oct. 30, 2019, which claims priority to Chinese Patent Application No. 201910210075.5 filed on Mar. 19, 2019. The disclosures of these applications are hereby incorporated by reference in their entirety.

### BACKGROUND

In processes of collecting, transmitting and receiving videos, the videos may usually be mixed with various noises, and the noises reduce the visual quality of the videos. For example, a video obtained using a relatively small aperture of a camera in a low-light scenario usually includes a noise, while the video including the noise also includes a large amount of information, and the noise in the video may make such information uncertain and seriously affect a visual experience of a viewer. Therefore, video denoising is of great research significance and has become an important research topic of computer vision.

However, a motion between continuous frames in a video or a camera shake cannot remove a noise completely and may easily cause loss of image details in the video or a blur or ghost at an image edge.

### SUMMARY

The disclosure relates to the technical field of computer vision, and particularly to a video processing method and apparatus and a non-transitory computer storage medium.

In some embodiments of the disclosure provides a video processing method, which may include:

acquiring a convolution parameter corresponding to a frame to be processed in a video sequence, the convolution parameter comprising a sampling point of a deformable convolution kernel and a weight of the sampling point; and

performing denoising processing on the frame to be processed based on the sampling point of the deformable convolution kernel and the weight of the sampling point to obtain a denoised video frame.

In some embodiments of the disclosure provides a video processing apparatus, which may include an acquisition unit and a denoising unit.

The acquisition unit may be configured to acquire a convolution parameter corresponding to a frame to be processed in a video sequence, the convolution parameter including a sampling point of a deformable convolution kernel and a weight of the sampling point.

The denoising unit may be configured to perform denoising processing on the frame to be processed based on the sampling point of the deformable convolution kernel and the weight of the sampling point to obtain a denoised video frame.

In some embodiments of the disclosure provides a video processing apparatus, which may include a memory and a processor.

The memory may be configured to store a computer program capable of running in the processor.

The processor may be configured to run the computer program to implement the operations of any method in some embodiments of the disclosure provides a video processing method.

In some embodiments of the disclosure provides a non-transitory computer storage medium, which may store a video processing program, the video processing program being executed by at least one processor to implement the operations of any method in some embodiments of the disclosure provides a video processing method.

In some embodiments of the disclosure provides a terminal apparatus, which at least includes any video processing apparatus in some embodiments of the disclosure provides a video processing apparatus.

In some embodiments of the disclosure provides a computer program product, which may store a video processing program, the video processing program being executed by at least one processor to implement the operations of any method in some embodiments of the disclosure provides a video processing method.

### BRIEF DESCRIPTION OF THE DRAWINGS

FIG. 1 is a flowchart of a video processing method according to an embodiment of the disclosure.

FIG. 2 is a structure diagram of a deep Convolutional Neural Network (CNN) according to an embodiment of the disclosure.

FIG. 3 is a flowchart of another video processing method according to an embodiment of the disclosure.

FIG. 4 is a flowchart of another video processing method according to an embodiment of the disclosure.

FIG. 5 is a flowchart of yet another video processing method according to an embodiment of the disclosure.

FIG. 6 is a schematic diagram of an overall architecture of a video processing method according to an embodiment of the disclosure.

FIG. 7 is a flowchart of yet another video processing method according to an embodiment of the disclosure.

FIG. 8 is a schematic diagram of a detailed architecture of a video processing method according to an embodiment of the disclosure.

FIG. 9 is a composition structure diagram of a video processing apparatus according to an embodiment of the disclosure.

FIG. 10 is a specific hardware structure diagram of a video processing apparatus according to an embodiment of the disclosure.

FIG. 11 is a composition structure diagram of a terminal apparatus according to an embodiment of the disclosure.

### DETAILED DESCRIPTION

The technical solutions in the embodiments of the disclosure will be clearly and completely described below in combination with the drawings in the embodiments of the disclosure.

The embodiments of the disclosure provide a video processing method. The method may be applied to a video processing apparatus. The apparatus may be arranged in a mobile terminal device such as a smart phone, a tablet computer, a notebook computer, a palm computer, a Personal Digital Assistant (PDA), a Portable Media Player (PMP), a wearable device and a navigation device, and may also be arranged in a fixed terminal device such as a digital TV and a desktop computer. No specific limits are made in the embodiments of the disclosure.

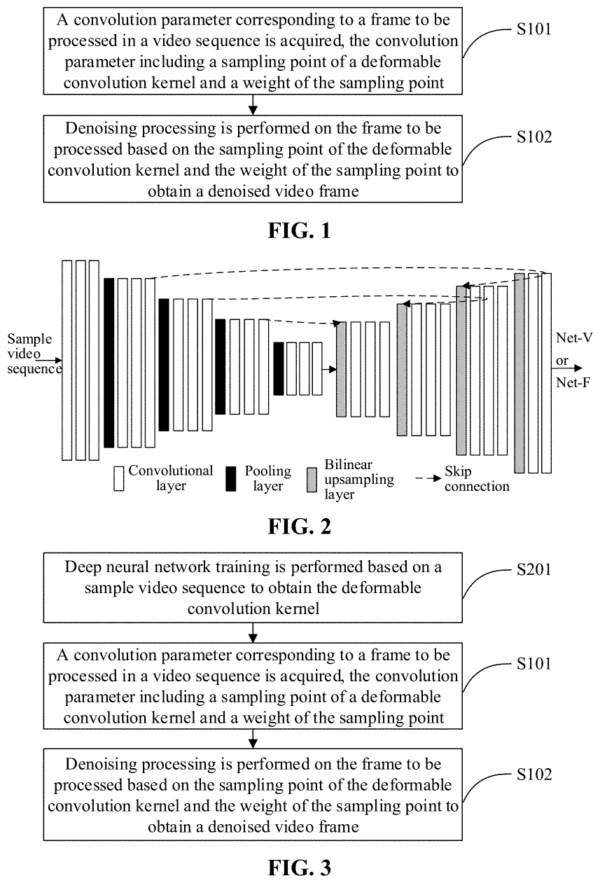

Referring to FIG. 1, a flowchart of a video processing method provided in the embodiments of the disclosure is shown. The method may include the following operations.

In operation S101, a convolution parameter corresponding to a frame to be processed in a video sequence is acquired, the convolution parameter including a sampling point of a deformable convolution kernel and a weight of the sampling point.

It is to be noted that a video sequence may be captured by collection through a camera, a smart phone, a tablet computer or many other terminal devices. A miniature camera and a terminal device such as a smart phone and a tablet computer are usually provided with relatively small image sensors and non-ideal optical devices. In such case, denoising processing on video frames is particularly important to these devices. High-end cameras, video cameras and the like are usually provided with larger image sensors and better optical devices, video frames captured by these devices can have high imaging quality under normal light conditions, but video frames captured in low-light scenarios usually include a lot of noises, and in such case, it is still necessary to perform denoising processing on the video frames.

In such case, a video sequence may be acquired by a camera, a smart phone, a tablet computer or many other terminal devices. The video sequence includes a frame to be processed that denoising processing is to be performed on. Deep neural network training may be performed on continuous frames (i.e., multiple continuous video frames) in the video sequence to obtain a deformable convolution kernel. Then, a sampling point of the deformable convolution kernel and a weight of a sampling point may be acquired and determined as a convolution parameter of the frame to be processed.

In some embodiments, a deep convolutional neural network (CNN) is a feed-forward neural network involving convolution operation and having a deep structure, which is one of representative algorithms for deep learning of a deep neural network.

Referring to FIG. 2, a structure diagram of a deep CNN provided in the embodiments of the disclosure is shown. As shown in FIG. 2, the deep CNN structurally includes convolutional layers, pooling layers and bilinear upsampling layers. A layer filled with no color is the convolutional layer. A layer filled with black is the pooling layer. A layer filled with gray is the bilinear upsampling layer. The amount of channel corresponding to each layer (i.e., the amount of deformable convolution kernels in each convolutional layer) is shown in Table 1. It can be seen from Table 1 that first 25 layers of a coordinate prediction network (represented with a V network) have the same amount of channels as a weight prediction network (represented with an F network), which indicates that the V network and the F network may share feature information of the first 25 layers, so that calculations of the networks may be solved by sharing of the feature information. The F network may be configured to acquire a predicted weight of the deformable convolution kernel through a sample video sequence (i.e., multiple continuous video frames), and the V network may be configured to acquire a predicted coordinate of the deformable convolution kernel through the sample video sequence (i.e., the multiple continuous video frames). The sampling point of the deformable convolution kernel may be obtained based on the predicted coordinate of the deformable convolution kernel. The weight of the sampling point of the deformable convolution kernel may be obtained based on the predicted weight of the deformable convolution kernel and the predicted coordinate of the deformable convolution kernel, and the convolution parameter is then obtained.

TABLE 1

| Layer | 1-3 | 4-6 | 7-9 | 10-12 | 13-15 | 16-18 | 19-21 | 22-25 | 26 | 27 |
|---|---|---|---|---|---|---|---|---|---|---|
| Net-F | 64 | 128 | 256 | 512 | 512 | 512 | 256 | 128 | 64 | N |
| (F network) | | | | | | | | | | |
| Net-V | 64 | 128 | 256 | 512 | 512 | 512 | 256 | 128 | 128 | 3N |
| (V network) | | | | | | | | | | |

In operation S102, denoising processing is performed on the frame to be processed based on the sampling point of the deformable convolution kernel and the weight of the sampling point to obtain a denoised video frame.

It is to be noted that, after the convolution parameter corresponding to the frame to be processed is acquired, convolution operation processing may be performed on the sampling point of the deformable convolution kernel, the weight of the sampling point and the frame to be processed, and a convolution operation result is the denoised video frame.

Specifically, in some embodiments, for the operation in S102 that denoising processing is performed on the frame to be processed based on the sampling point of the deformable convolution kernel and the weight of the sampling point to obtain the denoised video frame, the method may include that:

convolution processing is performed on the sampling point of the deformable convolution kernel, the weight of the sampling point and the frame to be processed to obtain the denoised video frame.

That is, denoising processing for the frame to be processed may be implemented by performing convolution processing on the sampling point of the deformable convolution kernel, the weight of the sampling point and the frame to be processed. For example, for each pixel in the frame to be processed, weighted summation may be performed on the each pixel, the sampling point of the deformable convolution kernel and the weight of the sampling point to obtain a denoised pixel value corresponding to each pixel, thereby implementing denoising processing on the frame to be processed.

In the embodiments of the disclosure, the video sequence includes the frame to be processed that denoising processing is to be performed on. The convolution parameter corresponding to the frame to be processed in the video sequence may be acquired, the convolution parameter including the sampling point of the deformable convolution kernel and the weight of the sampling point. Denoising processing may be performed on the frame to be processed based on the sampling point of the deformable convolution kernel and the weight of the sampling point to obtain the denoised video frame. The convolution parameter may be obtained by extracting information of continuous frames of a video. Therefore, the problems such as image blurs, detail loss and ghosts caused by a motion between frames in the video can be effectively solved. Moreover, the weight of the sampling point may also be changed along with change of a position of the sampling point, so that a better video denoising effect can be achieved, and the imaging quality of the video is improved.

For obtaining the deformable convolution kernel, referring to FIG. 3, a flowchart of another video processing method provided in the embodiments of the disclosure is shown. As shown in FIG. 3, before the operation that the convolution parameter corresponding to the frame to be processed in the video sequence is acquired, namely before S101, the method may further include the following operation.

In operation S201, deep neural network training is performed based on a sample video sequence to obtain the deformable convolution kernel.

It is to be noted that multiple continuous video frames may be selected from the video sequence as the sample video sequence. The sample video sequence not only includes a sample reference frame but also includes at least one adjacent frame which neighbors the sample reference frame. Herein, the at least one adjacent frame may be at least one adjacent frame forwards neighboring the sample reference frame, or may also be at least one adjacent frame backwards neighboring the sample reference frame, or may also be multiple adjacent frames forwards and backwards neighboring the sample reference frame. No specific limits are made in the embodiments of the disclosure. Descriptions will be made below under the condition that the multiple adjacent frames forwards and backwards neighboring the sample reference frame are determined as the sample video sequence as an example. For example, there is made such a hypothesis that the sample reference frame is a 0th frame in the video sequence. The at least one adjacent frame neighboring the sample reference frame may include a Tth frame, (T-1)th frame, . . . , second frame and first frame that are forwards adjacent to the 0th frame, or may include a first frame, second frame, . . . , (T-1)th frame and Tth frame that are backwards adjacent to the 0th frame. Namely, the sample video sequence includes totally 2T+1 frames and these frames are continuous frames.

In the embodiments of the disclosure, deep neural network training may be performed on the sample video sequence to obtain the deformable convolution kernel, and convolution operation processing may be performed on each pixel in the frame to be processed and a corresponding deformable convolution kernel to implement denoising processing on the frame to be processed. Compared with a fixed convolution kernel in related art, the deformable convolution kernel in the embodiments of the disclosure may achieve a better denoising effect for video processing of a frame to be processed. In addition, since three-dimensional convolution operation is performed in the embodiments of the disclosure, the corresponding deformable convolution kernel is also three-dimensional. Unless otherwise specified, all the deformable convolution kernels in the embodiments of the disclosure are three-dimensional deformable convolution kernels.

In some embodiments, for the sampling point of the deformable convolution kernel and the weight of the sampling point, coordinate prediction and weight prediction may be performed on the multiple continuous video frames in the sample video sequence through a deep neural network. A predicted coordinate and a predicted weight of the deformable convolution kernel are obtained, and then the sampling point of the deformable convolution kernel and the weight of the sampling point may be obtained based on coordinate prediction and weight prediction.

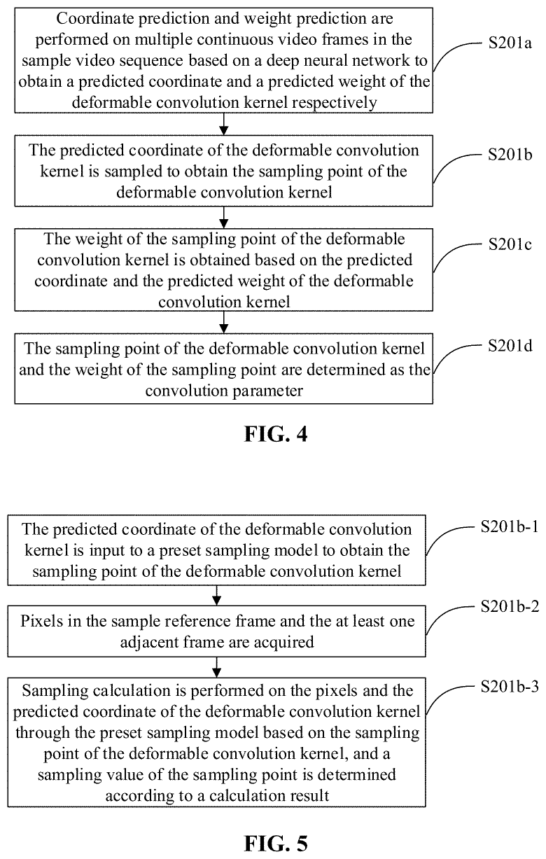

In some embodiments, referring to FIG. 4, a flowchart of another video processing method provided in the embodiments of the disclosure is shown. As shown in FIG. 4, for the operation in S201 that deep neural network training is performed based on the sample video sequence to obtain the deformable convolution kernel, the method may include the following operations.

In operation S201a, coordinate prediction and weight prediction are performed on multiple continuous video frames in the sample video sequence based on a deep neural network to obtain a predicted coordinate and a predicted weight of the deformable convolution kernel respectively.

It is to be noted that the multiple continuous video frames include a sample reference frame and at least one adjacent frame of the sample reference frame. When the at least one adjacent frame includes T forwards adjacent frames and T backwards adjacent frames, the multiple continuous video frames are totally 2T+1 frames. Deep learning is performed on the multiple continuous video frames (for example, the totally 2T+1 frames) through the deep neural network, and the coordinate prediction network and the weight prediction network are constructed according to a learning result. Then, coordinate prediction may be performed by the coordinate prediction network to obtain the predicted coordinate of the deformable convolution kernel, and weight prediction may be performed by the weight prediction network to obtain the predicted weight of the deformable convolution kernel. Herein, the frame to be processed may be the sample reference frame in the sample video sequence, and video denoising processing is performed on the sample reference frame.

Exemplarily, it is assumed that a width of each frame in the sample video sequence is represented with W and a height is represented with H, the number of pixels in the frame to be processed is H×W. Since the deformable convolution kernel is three-dimensional and a size of the deformable convolution kernel is N sampling points, the number of predicted coordinates, that can be acquired, of the deformable convolution kernel in the frame to be processed is H×W×N×3, and the number of predicted weights, that can be acquired, of the deformable convolution kernel in the frame to be processed is H×W×N.

In operation S201b, the predicted coordinate of the deformable convolution kernel is sampled to obtain the sampling point of the deformable convolution kernel.

It is to be noted that, after the predicted weight of the deformable convolution kernel and the predicted weight of the deformable convolution kernel are acquired, the predicted coordinate of the deformable convolution kernel may be sampled, so that the sampling point of the deformable convolution kernel can be obtained.

Specifically, sampling processing may be performed on the predicted coordinate of the deformable convolution kernel through a preset sampling model. In some embodiments, referring to FIG. 5, a flowchart of another video processing method provided in the embodiments of the disclosure is shown. As shown in FIG. 5, for the operation in S201b that the predicted coordinate of the deformable convolution kernel is sampled to obtain the sampling point of the deformable convolution kernel, the method may include the following operation.

In operation S201b-1, the predicted coordinate of the deformable convolution kernel is input to a preset sampling model to obtain the sampling point of the deformable convolution kernel.

It is to be noted that the preset sampling model represents a preset model for performing sampling processing on the predicted coordinate of the deformable convolution kernel. In the embodiments of the disclosure, the preset sampling model may be a trilinear sampler or another sampling model. No specific limits are made in the embodiments of the disclosure.

After the sampling point of the deformable convolution kernel is obtained based on the preset sampling model, the method may further include the following operations.

In operation S201b-2, pixels in the sample reference frame and the at least one adjacent frame are acquired.

It is to be noted that, when the sample reference frame and the at least one adjacent frame include totally 2T+1 frames, the width of each frame is represented with W and the height is represented with H, the number of pixels that can be acquired is H×W×(2T+1).

In operation S201b-3, sampling calculation is performed on the pixels and the predicted coordinate of the deformable convolution kernel through the preset sampling model based on the sampling point of the deformable convolution kernel, and a sampling value of the sampling point is determined according to a calculation result.

It is to be noted that, based on the preset sampling model, all the pixels and the predicted coordinate of the deformable convolution kernel may be input to the preset sampling model and an output of the preset sampling model is sampling points of the deformable convolution kernel and sampling values of the sampling points. Therefore, if the number of the obtained sampling points is H×W×N, then the number of the corresponding sampling values is also H×W×N.

Exemplarily, the trilinear sampler is taken as an example. The trilinear sampler can not only determine the sampling point of the deformation convolution kernel based on the predicted coordinate of the deformable convolution kernel but also determine the sampling value corresponding to the sampling point. For example, for 2T+1 frames in the sample video sequence, the 2T+1 frames include a sample reference frame, T adjacent frames forwards adjacent to the sample reference frame and T adjacent frames backwards adjacent to the sample reference frame, the number of pixels in the 2T+1 frames is H×W×(2T+1), and pixel values corresponding to the H33 W×(2T+1) pixels and H×W×N×3 predicted coordinates are input to the trilinear sampler for sampling calculation. For example, sampling calculation of the trilinear sampler is shown as the formula (1):

$$\hat{X} ( y , x , n ) = {\sum }_{i = 1}^{H} {\sum }_{j = 1}^{W} {\sum }_{m = - T}^{T} X ( x , j , m ) \cdot max ( 0 , 1 - \vert y + {v}_{( y , x , n )} - i \vert ) \cdot max ( 0 , 1 - \vert x + {u}_{( y , x , n )} - j \vert ) \cdot max ( 0 , 1 - \vert {z}_{( y , x , n )} - m \vert ) . \qquad ( 1 )$$

\hat{X}(y, x, n) represents a sampling value of an nth sampling point at a pixel position (y,x), n being a positive integer larger than or equal to 1 and less than or equal to N; u_{(y,x,n)}, v_{(y,x,n)}, z_{(y,x,n)} represent predicted coordinates corresponding to the nth sampling point at the pixel position (y,x) in three dimensions (a horizontal dimension, a vertical dimension and a time dimension) respectively; and X(i,j,m) represents a pixel value at a pixel position (i,j) in an mth frame in the video sequence.

In addition, for the deformable convolution kernel, the predicted coordinate of the deformable convolution kernel may be variable, and a relative offset may be added to a coordinate (xₙ, yₙ, tₙ) of each sampling point. Specifically, u_{(y,x,n)}, v_{y,x,n)}, z_{(y,x,n)} may be represented through the following formula respectively:

u_{(y,x,n)}=xₙ+V(y,x,n,1)

v_{(y,x,n)}=yₙ+V(y,x,n,2)

z_{(y,x,n)}32 tₙ+V(y,x,n,3) (2)

u_{(y,x,n)} represents the predicted coordinate corresponding to the nth sampling point at the pixel position (y,x) in the horizontal dimension; V(y,x,n,1) represents an offset corresponding to the nth sampling point at the pixel position (y,x) in the horizontal dimension; v_{(y,x,n)} represents the predicted coordinate corresponding to the nth sampling point at the pixel position (y,x) in the vertical dimension; V(y,x,n.3) represents an offset corresponding to the nth sampling point at the pixel position (y,x) in the vertical dimension; z_{(y,x,n)} represents the predicted coordinate corresponding to the nth sampling point at the pixel position (y,x) in the time dimension; and V(y,x,n,3) represents an offset corresponding to the nth sampling point at the pixel position (y,x) in the time dimension.

In the embodiments of the disclosure, the sampling point of the deformable convolution kernel may be determined on one hand, and on the other hand, the sampling value of each sampling point may be obtained. Since the predicted coordinate of the deformable convolution kernel is variable, it is indicated that a position of each sampling point is variable, that is, the deformable convolution kernel in the embodiments of the disclosure is not a fixed convolution kernel but a deformable convolution kernel. Compared with the fixed convolution kernel in related art, the deformable convolution kernel in the embodiments of the disclosure can achieve a better denoising effect for video processing of the frame to be processed.

In operation S201c, the weight of the sampling point of the deformable convolution kernel is obtained based on the predicted coordinate and the predicted weight of the deformable convolution kernel.

In operation S201d, the sampling point of the deformable convolution kernel and the weight of the sampling point are determined as the convolution parameter.

It is to be noted that, after the sampling point of the deformable convolution kernel is obtained, the weight of the sampling point of the deformable convolution kernel may be obtained based on the acquired predicted coordinate of the deformable convolution kernel and the predicted weight of the deformable convolution kernel, so that the convolution parameter corresponding to the frame to be processed is acquired. It is to be noted that the predicted coordinate mentioned here refers to a relative coordinate value of the deformable convolution kernel.

It is also to be noted that, in the embodiments of the disclosure, when the width of each frame in the sample video sequence is represented with W and the height is represented with H, since the deformable convolution kernel is three-dimensional and the size of the deformable convolution kernel is N sampling points, the number of predicted coordinates, that can be acquired, of the deformable convolution kernel in the frame to be processed is H×W×N×3, and the number of predicted weights, that can be acquired, of the deformable convolution kernel in the frame to be processed is H×W×N. In some embodiments, it may be obtained that the number of the sampling points of the deformable convolution kernel is H×W×N and the number of the weights of the sampling points is also H×W×N.

Exemplarily, the deep CNN shown in FIG. 2 is still taken as an example. There is made such a hypothesis that sizes of the deformable convolution kernels in each convolutional layer are the same, for example, the number of sampling points in the deformable convolution kernel is N. N may generally be valued to be 9, or may be specifically set based on a practical condition during a practical application. No specific limits are made in the embodiments of the disclosure. It is also to be noted that, for the N sampling points, in the embodiments of the disclosure, since the predicted coordinate of the deformable convolution kernel is variable, it is indicated that the position of each sampling point is not fixed and there is a relative offset for each sampling point based on the V network, and it is further indicated that the deformable convolution kernel in the embodiments of the disclosure is not a fixed convolution kernel but a deformable convolution kernel. Therefore, the embodiments of the disclosure may be applied to video processing in a case of a relatively large motion between frames. In addition, the weights of sampling points, obtained based on different sampling points in combination with the F network, are also different. That is, in the embodiments of the disclosure, not only is the deformable convolution kernel adopted, but also a variable weight is adopted. Compared with the related art where the fixed convolution kernel or a manually set weight is adopted, the embodiments can achieve a better denoising effect for video processing of a frame to be processed.

Based on the deep CNN shown in FIG. 2, the deep CNN also may adopt an encoder-decoder structure. In an operating stage of an encoder, downsampling may be performed for four times through the CNN, and in each downsampling, for an input frame to be processed H/2×W/2 (H represents the height of the frame to be processed, and W represents the width of the frame to be processed), an H/2×W/2 video frame may be obtained and output. The encoder is mainly configured to extract an image feature of the frame to be processed. In an operating stage of the decoder, upsampling may be performed for four times through the CNN, and in each upsampling, for an input frame to be processed H×W (H represents the height of the frame to be processed, and W represents the width of the frame to be processed), a 2H×2W video frame may be obtained and output. The decoder is mainly configured to restore a video frame with an original size based on the feature image extracted by the encoder. Herein, the number of times of downsampling or upsampling may be specifically set based on a practical condition, and is not specifically limited in the embodiments of the disclosure. In addition, it can also be seen from FIG. 2 that connection relationships, i.e., skip connections, are formed between outputs and inputs of part of convolutional layers. For example, a skip connection relationship may be formed between a 6th layer and a 22nd layer, a skip connection relationship may be formed between a 9th layer and a 19th layer, and a skip connection relationship may be formed between a 12th layer and a 16th layer. Therefore, low-order and high-order features may be comprehensively utilized in the decoder stage to bring a better video denoising effect to a frame to be processed.

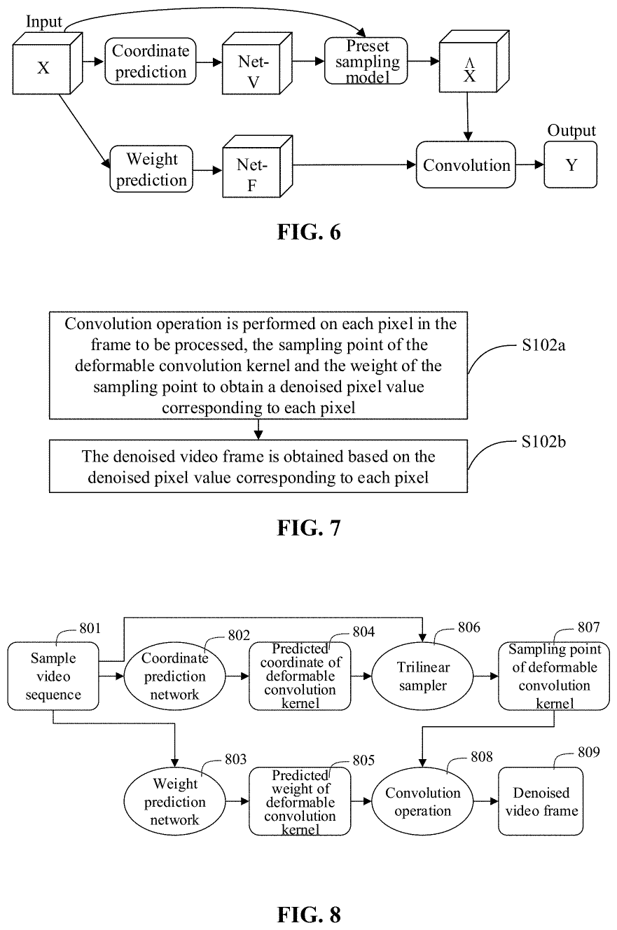

Referring to FIG. 6, a schematic diagram of an overall architecture of a video processing method provided in the embodiments of the disclosure is shown. As shown in FIG. 6, X represents an input end configured to input a sample video sequence. The sample video sequence is selected from a video sequence, and the sample video sequence may include five continuous frames (for example, including the sample reference frame, two adjacent frames forwards adjacent to the sample reference frame and two adjacent frames backwards adjacent to the sample reference frame). Then, coordinate prediction and weight prediction are performed on the continuous frames input by the X. For coordinate prediction, a coordinate prediction network (represented with the V network) may be constructed, and a predicted coordinate of the deformable convolution kernel may be obtained through the V network. For weight prediction, a weight prediction network (represented with the F network) may be constructed, and a predicted weight of the deformable convolution kernel may be obtained through the F network. Then, the continuous frames input by the X and the predicted coordinate, obtained by prediction, of the deformable convolution kernel are input to a preset sampling model, and a sampling point (represented with \hat{X}) of the deformable convolution kernel may be output through the preset sampling model. The weight of the sampling point of the deformable convolution kernel may be obtained based on the sampling point of the deformable convolution kernel and the predicted weight of the deformable convolution kernel. Finally, convolution operation is performed on each pixel in the frame to be processed, the sampling point of the deformable convolution kernel and the weight of the sampling point to obtain a denoised pixel value corresponding to each pixel in the frame to be processed, and an output result is the denoised video frame (represented with Y). Based on information of continuous frames in the video sequence, denoising processing on the frame to be processed is implemented. In addition, since the position of the sampling point of the deformable convolution kernel is variable (namely the deformable convolution kernel is adopted) and the weight of each sampling point is also variable, a better video denoising effect can be achieved.

After the operation S101, the sampling point of the deformable convolution kernel and the weight of the sampling point may be acquired. Therefore, denoising processing may be performed on the frame to be processed based on the sampling point of the deformable convolution kernel and the weight of the sampling point to obtain the denoised video frame.

Specifically, the denoised video frame may be obtained by performing convolution processing on the sampling point of the deformable convolution kernel, the weight of the sampling point and the frame to be processed. In some embodiments, referring to FIG. 7, a flowchart of another video processing method provided in the embodiments of the disclosure is shown. As shown in FIG. 7, for the operation that convolution processing is performed on the sampling point of the deformable convolution kernel, the weight of the sampling point and the frame to be processed to obtain the denoised video frame, the method may include the following operations.

In operation S102a, convolution operation is performed on each pixel in the frame to be processed, the sampling point of the deformable convolution kernel and the weight of the sampling point to obtain a denoised pixel value corresponding to each pixel.

It is to be noted that the denoised pixel value corresponding to each pixel may be obtained by performing weighted summation calculation on each pixel in the frame to be processed, the sampling point of the deformable convolution kernel and the weight of the sampling point. Specifically, in some embodiments, the operation S102a may include the following operations.

In operation S102a-1, weighted summation calculation is performed on each pixel, the sampling point of the deformable convolution kernel and the weight of the sampling point.

In operation S102a-2, the denoised pixel value corresponding to each pixel is obtained according to a calculation result.

It is to be noted that the denoised pixel value corresponding to each pixel in the frame to be processed may be obtained by performing weighted summation calculation on each pixel based on the sampling point of the deformable convolution kernel and a weight value of the sampling point. Specifically, the deformable convolution kernel, which is to, together with each pixel in the frame to be processed, subject to convolution, may include N sampling points, and in such a case, weighted calculation is performed on a sampling value of each sampling point and a weight of each sampling point and then summation calculation is performed on the N sampling points, and a final result is the denoised pixel value corresponding to each pixel in the frame to be processed, specifically referring to the formula (3):

$$Y ( y , x ) = {\sum }_{n = 1}^{N} \hat{X} ( y , x , n ) \cdot F ( y , x , n ) . \qquad ( 3 )$$

Y(y,x) represents a denoised pixel value at the pixel position (y,x) in the frame to be processed, \hat{X}(y,x,n) represents a sampling value of a nth sampling point at the pixel position (y,x), and F(y,x,n) represents a weight value of the nth sampling point at the pixel position (y,x), n=1,2, . . . , N.

In such a manner, the denoised pixel value corresponding to each pixel in the frame to be processed may be obtained by calculation through the formula (3). In the embodiments of the disclosure, the position of each sampling point is not fixed, and the weights of the sampling points are also different. That is, for denoising processing in the embodiments of the disclosure, not only is a deformable convolution kernel adopted, but also a variable weight is adopted. Compared with the related art where a fixed convolution kernel or a manually set weight is adopted, the embodiments can achieve a better denoising effect for video processing on a frame to be processed.

In operation S102b, the denoised video frame is obtained based on the denoised pixel value corresponding to each pixel.

It is to be noted that convolution operation processing may be performed on each pixel in a frame to be processed and a corresponding deformable convolution kernel, namely, convolution operation processing may be performed on each pixel in the frame to be processed, a sampling point of the deformable convolution kernel and a weight of the sampling point to obtain a denoised pixel value corresponding to each pixel. In such a manner, denoising processing on a frame to be processed is implemented.

Exemplarily, there is made such a hypothesis that the preset sampling model is a trilinear sampler. FIG. 8 is a schematic diagram of a detailed architecture of a video processing method according to an embodiment of the disclosure. As shown in FIG. 8, a sample video sequence 801 may be input first and the sample video sequence 801 includes multiple continuous video frames (for example, including a sample reference frame, two adjacent frames forwards adjacent to the sample reference frame and two adjacent frames backwards adjacent to the sample reference frame). Then, coordinate prediction and weight prediction may be performed on the input sample video sequence 801 based on a deep neural network. For example, a coordinate prediction network 802 and a weight prediction network 803 may be constructed. In such a manner, coordinate prediction may be performed based on the coordinate prediction network 802 to acquire a predicted coordinate 804 of a deformable convolution kernel, and weight prediction may be performed based on the weight prediction network 803 to acquire a predicted weight 805 of the deformable convolution kernel. The input sample video sequence 801 and the predicted coordinate 804 of the deformable convolution kernel may be input to a trilinear sampler 806, the trilinear sampler 806 may perform sampling processing, and an output of the trilinear sampler 806 is a sampling point 807 of the deformable convolution kernel. Then, convolution operation 808 may be performed on the sampling point 807 of the deformable convolution kernel and the predicted weight 805 of the deformable convolution kernel to finally output a denoised video frame 809. It is to be noted that, before convolution operation 808, a weight of the sampling point of the deformable convolution kernel may be obtained based on the predicted coordinate 804 of the deformable convolution kernel and the predicted weight 805 of the deformable convolution kernel. Therefore, for convolution operation 808, convolution operation may be performed on the sampling point of the deformable convolution kernel, the weight of the sampling point and the frame to be processed to implement denoising processing on the frame to be processed.

Based on the detailed architecture shown in FIG. 8, deep neural network training may be performed on a sample video sequence through a deep neural network to obtain a deformable convolution kernel. In addition, for a predicted coordinate and a predicted weight of the deformable convolution kernel, since the predicted coordinate is variable, it is indicated that the position of each sampling point is variable, and it is further indicated that the convolution kernel in the embodiments of the disclosure is not a fixed convolution kernel but a deformable convolution kernel. Therefore, the embodiments of the disclosure may be applied to video processing in a case of a relatively large motion between frames. In addition, based on different sampling points, the weight of each sampling point is also variable. That is, in the embodiments of the disclosure, not only is the deformable convolution kernel adopted, but also the variable predicted weight is adopted. Therefore, a better denoising effect can be achieved for video processing of a frame to be processed.

In the embodiments of the disclosure, a deformable convolution kernel is adopted, so that the problems such as image blurs, detail loss and ghosts caused by a motion between frames in continuous video frames are solved, different sampling points can be adaptively allocated based on pixel-level information to track a movement of the same position in the continuous video frames, the deficiency of information of a single frame may be compensated better by use of information of multiple frames, so that the method of the embodiments of the disclosure can be applied to a video restoration scenario. In addition, the deformable convolution kernel may also be considered as an efficient sequential optical-flow extractor, information of multiple frames in the continuous video frames can be fully utilized, and the method of the embodiments of the disclosure also can be applied to another pixel-level information-dependent video processing scenario. Moreover, under limited hardware quality or a low-light condition, high-quality video imaging also can be achieved based on the method of the embodiments of the disclosure.

According to the video processing method provided in the embodiments, a convolution parameter corresponding to a frame to be processed in the video sequence may be acquired, the convolution parameter including a sampling point of a deformable convolution kernel and a weight of the sampling point; and denoising processing may be performed on the frame to be processed based on the sampling point of the deformable convolution kernel and the weight of the sampling point to obtain a denoised video frame. The convolution parameter may be obtained by extracting information of continuous frames of a video, so that the problems such as image blurs, detail loss and ghosts caused by a motion between frames in the video can be effectively solved. Moreover, the weight of the sampling point may be changed along with change of the position of the sampling point, so that a better video denoising effect can be achieved, and the imaging quality of the video is improved.

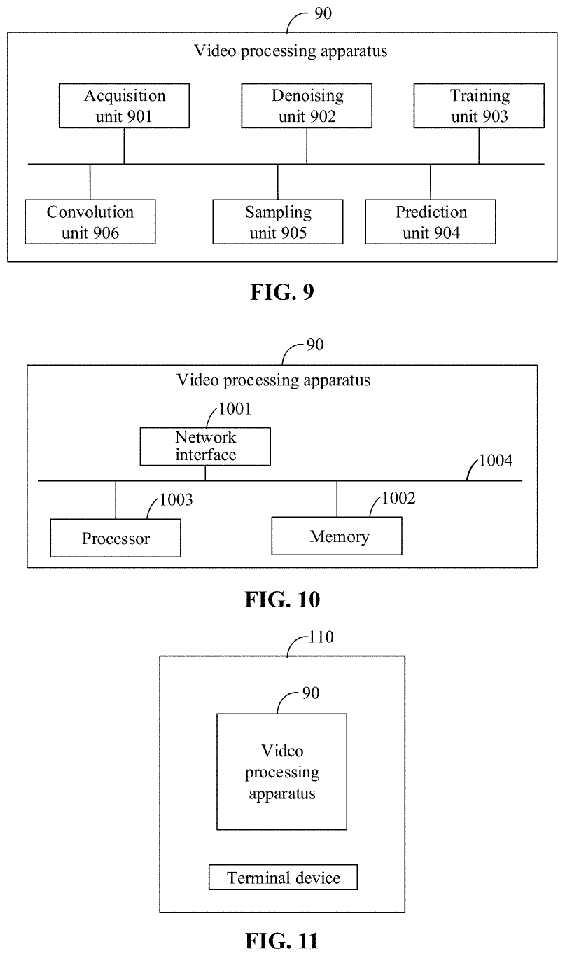

Based on the same inventive concept of the abovementioned embodiments, referring to FIG. 9, a composition of a video processing apparatus 90 provided in the embodiments of the disclosure is shown. The video processing apparatus 90 may include an acquisition unit 902 and a denoising unit 902.

The acquisition unit 901 is configured to acquire a convolution parameter corresponding to a frame to be processed in a video sequence, the convolution parameter including a sampling point of a deformable convolution kernel and a weight of the sampling point.

The denoising unit 902 is configured to perform denoising processing on the frame to be processed based on the sampling point of the deformable convolution kernel and the weight of the sampling point to obtain a denoised video frame.

In the solution, referring to FIG. 9, the video processing apparatus 90 further includes a training unit 903, configured to perform deep neural network training based on a sample video sequence to obtain the deformable convolution kernel.

In the solution, referring to FIG. 9, the video processing apparatus 90 further includes a prediction unit 904 and a sampling unit 905.

The prediction unit 904 is configured to perform coordinate prediction and weight prediction on multiple continuous video frames in the sample video sequence based on a deep neural network to obtain a predicted coordinate and a predicted weight of the deformable convolution kernel respectively, the multiple continuous video frames including a sample reference frame and at least one adjacent frame of the sample reference frame.

The sampling unit 905 is configured to sample the predicted coordinate of the deformable convolution kernel to obtain the sampling point of the deformable convolution kernel.

The acquisition unit 901 is further configured to obtain the weight of the sampling point of the deformable convolution kernel based on the predicted coordinate and the predicted weight of the deformable convolution kernel and determine the sampling point of the deformable convolution kernel and the weight of the sampling point as the convolution parameter.

In the solution, the sampling unit 905 is specifically configured to input the predicted coordinate of the deformable convolution kernel to a preset sampling model to obtain the sampling point of the deformable convolution kernel.

In the solution, the acquisition unit 901 is further configured to acquire pixels in the sample reference frame and the at least one adjacent frame.

The sampling unit 905 is further configured to perform sampling calculation on the pixels and the predicted coordinate of the deformable convolution kernel through the preset sampling model based on the sampling point of the deformable convolution kernel and determine a sampling value of the sampling point according to a calculation result.

In the solution, the denoising unit 902 is specifically configured to perform convolution processing on the sampling point of the deformable convolution kernel, the weight of the sampling point and the frame to be processed to obtain the denoised video frame.

In the solution, referring to FIG. 9, the video processing apparatus 90 further includes a convolution unit 906, configured to perform convolution operation on each pixel in the frame to be processed, the sampling point of the deformable convolution kernel and the weight of the sampling point to obtain a denoised pixel value corresponding to each pixel.

The denoising unit 902 is specifically configured to obtain the denoised video frame based on the denoised pixel value corresponding to each pixel in the frame to be processed.

In the solution, the convolution unit 906 is specifically configured to perform weighted summation calculation on each pixel in the frame to be processed, the sampling point of the deformable convolution kernel and the weight of the sampling point and obtain the denoised pixel value corresponding to each pixel according to a calculation result.

It can be understood that, in the embodiment, “unit” may be part of a circuit, part of a processor, part of a program or software and the like, and of course, may also be modular or non-modular. In addition, each component in the embodiments may be integrated into a processing unit. Each unit may also exist independently. Two or more than two units may also be integrated into a unit. The integrated unit may be implemented in a hardware form or in form of software function module.

When implemented in form of software function module and sold or used not as an independent product, the integrated unit may be stored in a computer-readable storage medium. Based on such an understanding, the technical solution of the embodiments substantially or parts making contributions to the related art or all or part of the technical solution may be embodied in form of software product. The computer software product is stored in a non-transitory computer storage medium, including a plurality of instructions configured to enable a computer device (which may be a personal computer, a server, a network device or the like) or a processor to execute all or part of the operations of the method in the embodiments. The storage medium may include: various media capable of storing program codes such as a U disk, a mobile hard disk, a Read-Only Memory (ROM), a Random Access Memory (RAM), a magnetic disk or an optical disk.

Therefore, an embodiment provides a non-transitory computer storage medium, which stores a video processing program, the video processing program being executable by at least one processor to implement the operations of the method in the abovementioned embodiments.

Based on the composition of the video processing apparatus 90 and the non-transitory computer storage medium, referring to FIG. 10, a specific hardware structure of the video processing 90 provided in the embodiments of the disclosure is shown, which may include a network interface 1001, a memory 1002 and a processor 1003. Each component is coupled together through a bus system 1004. It can be understood that the bus system 1004 is configured to implement connection communication between these components. The bus system 1004 includes a data bus and further includes a power bus, a control bus and a state signal bus. However, for clear description, various buses in FIG. 10 are marked as the bus system 1004. The network interface 1001 is configured to receive and send a signal in a process of receiving and sending information with another external network element.

The memory 1002 is configured to store a computer program capable of running in the processor 1003.

The processor 1003 is configured to run the computer program to execute the following operations including that:

a convolution parameter corresponding to a frame to be processed in a video sequence is acquired, the convolution parameter including a sampling point of a deformable convolution kernel and a weight of the sampling point; and

denoising processing is performed on the frame to be processed based on the sampling point of the deformable convolution kernel and the weight of the sampling point to obtain a denoised video frame.

The embodiments of the application provide a computer program product, which stores a video processing program, the video processing program being executable by at least one processor to implement the operations of the method in the abovementioned embodiments.

It can be understood that the memory 1002 in the embodiments of the disclosure may be a volatile memory or a nonvolatile memory, or may include both the volatile and nonvolatile memories. The nonvolatile memory may be a ROM, a Programmable ROM (PROM), an Erasable PROM (EPROM), an Electrically EPROM (EEPROM) or a flash memory. The volatile memory may be a RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DRRAM). It is to be noted that the memory 1002 of a system and method described in the disclosure is intended to include, but not limited to, memories of these and any other proper types.

The processor 1003 may be an integrated circuit chip with a signal processing capability. In an implementation process, each operation of the method may be implemented by an integrated logic circuit of hardware in the processor 1003 or an instruction in a software form. The processor 1003 may be a universal processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, operation and logical block diagram in the embodiment of the disclosure may be implemented or executed. The universal processor may be a microprocessor or the processor may also be any conventional processor and the like. The operations of the method in combination with the embodiments of the disclosure may be directly embodied to be executed and completed by a hardware decoding processor or executed and completed by a combination of hardware and software modules in the decoding processor. The software module may be located in a mature storage medium in this field such as a RAM, a flash memory, a ROM, a PROM or EEPROM and a register. The storage medium is located in the memory 1002. The processor 1003 reads information in the memory 1002 and completes the operations of the method in combination with hardware.

It can be understood that these embodiments described in the disclosure may be implemented by hardware, software, firmware, middleware, a microcode or a combination thereof. In case of implementation with the hardware, the processing unit may be implemented in one or more ASICs, DSPs, DSP Devices (DSPDs), Programmable Logic Devices (PLDs), FPGAs, universal processors, controllers, microcontrollers, microprocessors, other electronic units configured to execute the functions in the disclosure or combinations thereof.

In a case of implementation with software, the technology of the disclosure may be implemented through the modules (for example, processes and functions) executing the functions in the disclosure. A software code may be stored in the memory and executed by the processor. The memory may be implemented in the processor or outside the processor.

Optionally, as another embodiment, the processor 1003 is further configured to run the computer program to implement the operations of the method in the abovementioned embodiments.

Referring to FIG. 11, a composition structure diagram of a terminal device 110 provided in the embodiments of the disclosure is shown. The terminal device 110 at least includes any video processing apparatus 90 involved in the abovementioned embodiments.

According to the video processing method and apparatus and non-transitory computer storage medium provided in the embodiments of the disclosure, a convolution parameter corresponding to a frame to be processed in a video sequence may be acquired at first, the convolution parameter including a sampling point of a deformable convolution kernel and a weight of a sampling point. The convolution parameter is obtained by extracting information of continuous frames of a video, so that the problems such as image blurs, detail loss and ghosts caused by a motion between frames in the video can be effectively solved. Then, denoising processing may be performed on the frame to be processed based on the sampling point of the deformable convolution kernel and the weight of the sampling point to obtain the denoised video frame. The weight of the sampling point may be changed based on different positions of the sampling point, so that a better video denoising effect can be achieved, and the imaging quality of the video is improved.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

The sequence numbers of the embodiments of the disclosure are adopted not to represent superiority-inferiority of the embodiments but only for description.

From the above descriptions about the implementation modes, those skilled in the art may clearly know that the method of the abovementioned embodiments may be implemented in a manner of combining software and a necessary universal hardware platform, and of course, may also be implemented through hardware, but the former is a preferred implementation mode under many circumstances. Based on such an understanding, the technical solutions of the disclosure substantially or parts making contributions to the related art may be embodied in form of software product, and the computer software product is stored in a non-transitory computer storage medium (for example, a ROM/RAM), a magnetic disk and an optical disk), including a plurality of instructions configured to enable a terminal (which may be a mobile phone, a server, an air conditioner, a network device or the like) to execute the method in each embodiment of the disclosure.

The embodiments of the disclosure are described above in combination with the drawings, but the disclosure is not limited to the abovementioned specific implementation modes. The abovementioned specific implementation modes are not restrictive but only schematic, those of ordinary skill in the art may be inspired by the disclosure to implement many forms without departing from the purpose of the disclosure and the scope of protection of the claims, and all these shall fall within the scope of protection of the disclosure.

What is claimed is:

1. A method for video processing, comprising:
acquiring a convolution parameter corresponding to a frame to be processed in a video sequence, the convolution parameter comprising a sampling point of a deformable convolution kernel and a weight of the sampling point; and
performing denoising processing on the frame to be processed based on the sampling point of the deformable convolution kernel and the weight of the sampling point to obtain a denoised video frame.

2. The method of claim 1, further comprising:
before acquiring the convolution parameter corresponding to the frame to be processed in the video sequence, performing deep neural network training based on a sample video sequence to obtain the deformable convolution kernel.

3. The method of claim 2, wherein performing deep neural network training based on the sample video sequence to obtain the deformable convolution kernel comprises:
performing coordinate prediction and weight prediction on multiple continuous video frames in the sample video sequence based on a deep neural network to obtain a predicted coordinate and a predicted weight of the deformable convolution kernel respectively, the multiple continuous video frames comprising a sample reference frame and at least one adjacent frame of the sample reference frame;
sampling the predicted coordinate of the deformable convolution kernel to obtain the sampling point of the deformable convolution kernel;
obtaining the weight of the sampling point of the deformable convolution kernel based on the predicted coordinate and the predicted weight of the deformable convolution kernel; and
determining the sampling point of the deformable convolution kernel and the weight of the sampling point as the convolution parameter.

4. The method of claim 3, wherein sampling the predicted coordinate of the deformable convolution kernel to obtain the sampling point of the deformable convolution kernel comprises:
inputting the predicted coordinate of the deformable convolution kernel to a preset sampling model to obtain the sampling point of the deformable convolution kernel.

5. The method of claim 4, further comprising:
after the sampling point of the deformable convolution kernel is obtained, acquiring pixels in the sample reference frame and the at least one adjacent frame; and
performing sampling calculation on the pixels and the predicted coordinate of the deformable convolution kernel through the preset sampling model based on the sampling point of the deformable convolution kernel, and determining a sampling value of the sampling point according to a calculation result.

6. The method of claim 1, wherein performing denoising processing on the frame to be processed based on the sampling point of the deformable convolution kernel and the weight of the sampling point to obtain the denoised video frame comprises:
performing convolution processing on the sampling point of the deformable convolution kernel, the weight of the sampling point and the frame to be processed to obtain the denoised video frame.

7. The method of claim 6, wherein performing convolution processing on the sampling point of the deformable convolution kernel, the weight of the sampling point and the frame to be processed to obtain the denoised video frame comprises:
performing convolution operation on each pixel in the frame to be processed, the sampling point of the deformable convolution kernel and the weight of the sampling point to obtain a denoised pixel value corresponding to each pixel; and
obtaining the denoised video frame based on the denoised pixel value corresponding to each pixel.

8. The method of claim 7, wherein performing convolution operation on each pixel in the frame to be processed, the sampling point of the deformable convolution kernel and the weight of the sampling point to obtain the denoised pixel value corresponding to each pixel comprises:
performing weighted summation calculation on each pixel in the frame to be processed, the sampling point of the deformable convolution kernel and the weight of the sampling point; and
obtaining the denoised pixel value corresponding to each pixel according to a calculation result.

9. A video processing apparatus, comprising a memory and a processor,
wherein the memory is configured to store a computer program capable of running in the processor; and
the processor is configured to run the computer program to implement operations comprising:
acquiring a convolution parameter corresponding to a frame to be processed in a video sequence, the convolution parameter comprising a sampling point of a deformable convolution kernel and a weight of the sampling point; and
performing denoising processing on the frame to be processed based on the sampling point of the deformable convolution kernel and the weight of the sampling point to obtain a denoised video frame.

10. The video processing apparatus of claim 9, wherein the processor is further configured to perform deep neural network training based on a sample video sequence to obtain the deformable convolution kernel.

11. The video processing apparatus of claim 10, wherein the processor is further configured to:
perform coordinate prediction and weight prediction on multiple continuous video frames in the sample video sequence based on a deep neural network to obtain a predicted coordinate and a predicted weight of the deformable convolution kernel respectively, the multiple continuous video frames comprising a sample reference frame and at least one adjacent frame of the sample reference frame;
sample the predicted coordinate of the deformable convolution kernel to obtain the sampling point of the deformable convolution kernel; and
obtain the weight of the sampling point of the deformable convolution kernel based on the predicted coordinate and the predicted weight of the deformable convolution kernel and determine the sampling point of the deformable convolution kernel and the weight of the sampling point as the convolution parameter.

12. The video processing apparatus of claim 11, wherein the processor is configured to input the predicted coordinate of the deformable convolution kernel to a preset sampling model to obtain the sampling point of the deformable convolution kernel.

13. The video processing apparatus of claim 12, wherein the processor is further configured to:
acquire pixels in the sample reference frame and the at least one adjacent frame; and
perform sampling calculation on the pixels and the predicted coordinate of the deformable convolution kernel through the preset sampling model based on the sampling point of the deformable convolution kernel and determine a sampling value of the sampling point according to a calculation result.

14. The video processing apparatus of claim 9, wherein the processor is configured to perform convolution processing on the sampling point of the deformable convolution kernel, the weight of the sampling point and the frame to be processed to obtain the denoised video frame.

15. The video processing apparatus of claim 14, wherein the processor is further configured to:
perform convolution operation on each pixel in the frame to be processed, the sampling point of the deformable convolution kernel and the weight of the sampling point to obtain a denoised pixel value corresponding to each pixel, and
obtain the denoised video frame based on the denoised pixel value corresponding to each pixel.

16. The video processing apparatus of claim 15, wherein the processor is specifically configured to perform weighted summation calculation on each pixel in the frame to be processed, the sampling point of the deformable convolution kernel and the weight of the sampling point and obtain the denoised pixel value corresponding to each pixel according to a calculation result.

17. A non-transitory computer storage medium, storing a video processing program, the video processing program being executed by at least one processor to implement operations comprising:
acquiring a convolution parameter corresponding to a frame to be processed in a video sequence, the convolution parameter comprising a sampling point of a deformable convolution kernel and a weight of the sampling point; and
performing denoising processing on the frame to be processed based on the sampling point of the deformable convolution kernel and the weight of the sampling point to obtain a denoised video frame.

18. The non-transitory computer storage medium of claim 17, wherein the video processing program is further executed by the at least one processor to implement an operation comprising:
before acquiring the convolution parameter corresponding to the frame to be processed in the video sequence, performing deep neural network training based on a sample video sequence to obtain the deformable convolution kernel.

19. A terminal apparatus, at least comprising the video processing apparatus of claim 9.

20. A computer program product, storing a video processing program, the video processing program being executed by at least one processor to implement the operations of the method of claim 1.
